(19) United States
(12) Patent Application Publication
(10) Pub. No.: US 2024/0380608 A1
(43) Pub. Date: Nov. 14, 2024

(54) ELECTRONIC DEVICE AND OPERATING METHOD THEREOF

(71) Applicant: Samsung Electronics Co., Ltd., Suwon-si (KR)

(72) Inventors: Juneho LEE, Suwon-si (KR); Hyojae LEE, Suwon-si (KR); Youngsang SHIN, Suwon-si (KR)

(21) Appl. No.: 18/604,033

(22) Filed: Mar. 13, 2024

(30) Foreign Application Priority Data
May 9, 2023 (KR) 10-2023-0060019

(51) Int. Cl. H04L 9/32

(52) U.S. Cl. CPC H04L 9/3247

(57) ABSTRACT

A method for operating an electronic device is disclosed. A method for operating an electronic device according to an embodiment of the disclosure may comprise: storing a first authentication value of a first application in a storage area accessible by an application having a specified digital signature, by the first application having a first digital signature capable of accessing the storage area, transmitting a function execution request and a second authentication value to a second application, by the first application, identifying a second digital signature of the second application based on identifying a request for access to the storage area of the second application, based on the second digital signature corresponding to the specified digital signature, allowing access to the storage area of the second application, performing authentication on the first application based on the first authentication value identified in the storage area and the second authentication value received from the first application, by the second application, and based on performing the authentication, performing a function corresponding to the function execution request, by the second application.

### CROSS-REFERENCE TO RELATED APPLICATION

This application is based on and claims priority under 35 U.S.C. § 119 to Korean Patent Application No. 10-2023-0060019, filed on May 9, 2023, in the Korean Intellectual Property Office, the disclosure of which is incorporated by reference herein in its entirety.

### BACKGROUND

### Field

The disclosure relates to an electronic device and an operating method of the electronic device.

### Description of Related Art

Due to the development of IoT technology, various electronic products have become interconnected and may provide more functions to users by sharing data with each other. It is possible to mutually share data and provide a better service through the connectivity technology of IoT devices. In this regard, various services may be provided to users through communication between applications of electronic products, and electronic devices may provide a platform that allows mutual use of functions between applications. For example, when an application wants to use a function provided by another application, a request for the function of the application may be transferred to the other application through an application programming interface (API). Accordingly, the other application may provide the function to the application.

Functions that are commonly provided by an application may be freely requested by any application. However, for functions requiring a specific permission, it is needed to identify whether an application is reliable in relation to providing functions between applications.

### SUMMARY

Embodiments of the disclosure provide a device and an operation method thereof for identifying whether an application requesting a function of another application is reliable.

A method for operating an electronic device according to an example embodiment of the disclosure may comprise: storing a first authentication value of a first application in a storage area accessible by an application having a specified digital signature, by the first application having a first digital signature capable of accessing the storage area; transmitting a function execution request and a second authentication value to a second application, by the first application; identifying a second digital signature of the second application based on identifying a request for access to the storage area of the second application; based on the second digital signature corresponding to the specified digital signature, allowing access to the storage area of the second application; performing authentication on the first application based on the first authentication value identified in the storage area and the second authentication value received from the first application, by the second application; and based on performing the authentication, performing a function corresponding to the function execution request, by the second application.

In an example embodiment, the function execution request may include information about a storage path of the first authentication value.

In an example embodiment, identifying the request for access to the storage area of the second application may include identifying a specified access path for the second application. In an example embodiment, identifying the request for access to the storage area of the second application may include identifying the storage area among areas accessible through the specified access path.

In an example embodiment, the storage area may include a partial area of an area storing data for the first application. In an example embodiment, data regarding an application other than the first application may not be stored.

In an example embodiment, the storage area may include a partial area of an area storing data regarding the first application and the second application.

In an example embodiment, the specified digital signature may include the first digital signature including a digital signature of the first application.

In an example embodiment, in the method for operating the electronic device, performing the function corresponding to the function execution request by the second application may include providing data regarding the function to the first application by the second application.

In an example embodiment, the method for operating an electronic device may further comprise: displaying a user interface informing that data corresponding to the function execution request may not be provided, based on information regarding the extracted first digital signature not being the same as information regarding the second digital signature.

In an example embodiment, the user interface may include an object for identifying an input regarding whether to provide a function regarding the second application to the first application.

In an example embodiment, the first authentication value may include a value randomly generated according to a time when the first authentication value is generated.

In an example embodiment, the storage area may include a partial area of a memory area of the electronic device.

In an example embodiment, the storage area may include a partial area of a memory area of a cloud server connected with the electronic device.

In an example embodiment, the first application may include an application installed on the electronic device, and the second application may include an application installed on an external electronic device connected with the electronic device.

An electronic device according to an example embodiment of the disclosure may comprise: memory and at least one processor, comprising processing circuitry, electrically connected to the memory. In an example embodiment, at least one processor, individually and/or collectively, may be configured to: store a first authentication value of a first application in a storage area accessible by an application having a specified digital signature, by the first application having a first digital signature capable of accessing the storage area; transmit a function execution request and a second authentication value to a second application, by the first application; identify a second digital signature of the second application based on identifying a request for access to the storage area of the second application; based on the second digital signature corresponding to the specified digital signature, allow access to the storage area of the second application; perform authentication on the first application based on the first authentication value identified in the storage area and the second authentication value received from the first application, by the second application; based on performing the authentication, perform a function corresponding to the function execution request, by the second application.

In an example embodiment, at least one processor, individually and/or collectively, may be configured to identify the request for access to the storage area of the second application. In an example embodiment, at least one processor, individually and/or collectively, may be configured to identify a specified access path for the second application. In an example embodiment, at least one processor, individually and/or collectively, may be configured to identify the storage area among areas accessible through the specified access path.

In an example embodiment, the storage area may include a partial area of an area storing data for the first application. In an example embodiment, data regarding an application other than the first application may not be stored.

In an example embodiment, the storage area may include a partial area of an area storing data regarding the first application and the second application.

In an example embodiment, the specified digital signature may include the first digital signature including a digital signature of the first application.

In an example embodiment, at least one processor, individually and/or collectively, may be configured to provide a data response including data corresponding to the function execution request to the first application.

The electronic device according to an example embodiment may further comprise: a display. In an example embodiment, at least one processor, individually and/or collectively, may be configured to display, through the display, a user interface informing that data corresponding to the function execution request may not be provided, based on information regarding the extracted first digital signature not being the same as information regarding the second digital signature.

According to the various example embodiments of the disclosure, it is possible to identify whether an application is reliable.

It is also possible to enable efficient authentication using digital signature to authenticate an application.

Effects of the disclosure are not limited to the foregoing, and other unmentioned effects would be apparent to one of ordinary skill in the art from the following description.

### BRIEF DESCRIPTION OF THE DRAWINGS

The above and other aspects, features, and advantages of certain embodiments of the disclosure will be more apparent from the following detailed description, taken in conjunction with the accompanying drawings, in which:

FIG. 1 is a block diagram illustrating an example configuration of an electronic device according to an embodiment of the disclosure;

FIG. 2 is a block diagram illustrating an example configuration of an electronic device according to an embodiment of the disclosure;

FIG. 3 is a diagram illustrating an example of communication between applications according to an embodiment of the disclosure;

FIG. 4 is a flowchart illustrating example operations of an electronic device for authentication of an application according to an embodiment of the disclosure;

FIG. 5 is a flowchart illustrating example operations of an electronic device for authentication of an application according to an embodiment of the disclosure; and

FIG. 6 is a diagram illustrating an example of a storage area of an electronic device according to an embodiment of the disclosure.

The same or similar reference denotations may be used to refer to the same or similar elements throughout the disclosure and the drawings.

### DETAILED DESCRIPTION

Embodiments of the disclosure are now described in greater detail below with reference to the accompanying drawings. However, the disclosure may be implemented in other various forms and is not limited to the example embodiments set forth herein. The same or similar reference denotations may be used to refer to the same or similar elements throughout the disclosure and the drawings. Further, for clarity and brevity, descriptions of well-known functions and configurations in the drawings and relevant descriptions may be omitted.

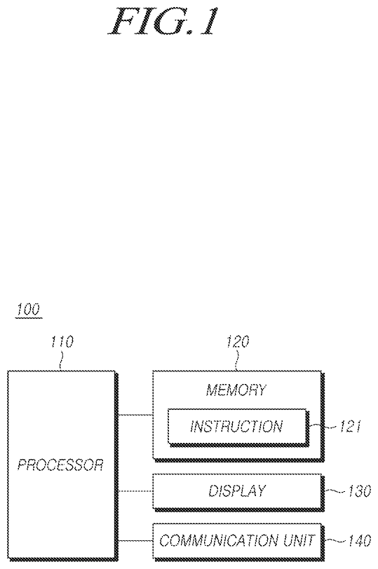

FIG. 1 is a block diagram illustrating an example configuration of an electronic device according to an embodiment of the disclosure. The electronic device 100 of FIG. 1 may include devices capable of performing various computing functions, such as video viewing and communication. For example, and without limitation, the electronic device may include TVs, PCs, laptops, smartphones, tablet PCs, personal digital assistants (PDAs), smart home appliances, and wearable devices, such as watches and glasses. The electronic device 100 may include a processor (e.g., including processing circuitry) 110, memory 120, a display 130, and a communication unit (e.g., including communication circuitry) 140.

According to an embodiment, the memory 120 may include at least one storage medium used by the electronic device 100 and may store data, such as at least one command 121 or configuration information corresponding to at least one program. The program may include an operating system (OS) program and various application programs. For example, the memory 120 may store a program that is a set of various instructions required when driving the electronic device 100. Here, the program may include an application (or application program) to provide a specific service.

The application may include one or more executable files that may run the application. The executable file refers to a file that performs an indicated task according to coded instructions, and may require access to resources depending on the content of the indicated task. For example, executable files may be files with an extension, such as ‘.exe’ in MS-DOS or Windows, elf files in Linux, files with an extension, such as ‘.dex’ in Android apps, but are not limited thereto.

The application program may further include access control information used to control resource access of the application program. The access control information may be stored in the application program in a form that is included in the executable file corresponding to each access control information. For example, the application program may attach access control information related to each of at least one executable file to the end of each executable file and store it. The access control information may include information about the resource of the electronic device 100 that needs to be accessed when executing the corresponding executable file.

In an embodiment, the memory 120 may store the application, at least one executable file included in the application, at least one access control information included in each executable file, and a digital signature for identifying whether it is tampered, through an installation process.

In an embodiment, the memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the display 130 may perform functions for outputting information in the form of numbers, characters, images, and/or graphics. The display 130 may include at least one hardware module for output. The at least one hardware module may include at least one of, for example, and without limitation, a liquid crystal display (LCD), a light emitting diode (LED), a light emitting polymer display (LPD), an organic light emitting diode (OLED), an active matrix organic light emitting diode (AMOLED), or flexible LED (FLED). The display 130 may display a screen corresponding to data received from the processor 110. The display 130 may be referred to as an ‘output unit’, a ‘display unit’, or by other terms having an equivalent technical meaning.

According to an embodiment, the communication unit 140 may include various communication circuitry and provide a wired/wireless communication interface enabling communication with an external device. The communication unit 140 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 110. The short-range communication unit may perform short-range communication wirelessly with an external device under the control of the processor 110. Short-range communication may include Bluetooth, Bluetooth low energy, infrared data association (IrDA), ultra-wideband (UWB), and near-field communication (NFC). The external device may include a server device and a mobile terminal (e.g., phone, tablet, etc.) providing, e.g., a video service.

According to an embodiment, the processor 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 110 may, for example, control at least one other component of the electronic device 100 and/or execute computation or data processing regarding communication by executing at least one command 121 stored in the memory 120. The processor 110 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

In an embodiment, the processor 110 may execute, e.g., software to control at least one other component (e.g., a hardware or software component) of the electronic device 100 connected with the processor 110 and may process or compute various data. According to an embodiment, as at least part of the data processing or computation, the processor 110 may store a command or data received from another component onto a volatile memory, process the command or the data stored in the volatile memory, and store resulting data in a non-volatile memory.

When receiving an execution command for the application, the processor 120 may drive the application using the executable file included in the application. In this case, the processor 120 may set a resource access permission for the application according to the access control information included in the executable file.

For example, the processor 120 may authenticate the digital signature that encrypts the executable file and the access control information to identify whether the executable file and the access control information are tampered, and set the resource access permission for the application according to the identification result.

Although not shown, the electronic device 100 may include an image input unit (not shown). According to an embodiment, the image input unit (not shown) may receive images and image information through a tuner (not shown), an input/output unit (not shown), or the communication unit 140. The image input unit (not shown) may include at least one of the tuner and the input/output unit. The tuner may tune and select only the frequency of the broadcast channel to be received by the electronic device 100 among many radio components, by amplifying, mixing, and resonating the broadcast signals wiredly/wirelessly received. The broadcast signal may include video, audio, and additional data (e.g., electronic program guide (EPG)). The tuner may receive real-time broadcast channels (or real-time viewing images) from various broadcast sources, such as terrestrial broadcasts, cable broadcasts, satellite broadcasts, Internet broadcasts, and the like. The tuner may be implemented integrally with the electronic device 100 or may be implemented as a separate tuner electrically connected to the electronic device 100. The input/output unit may include at least one of a high definition multimedia interface (HDMI) input port, a component input jack, a PC input port, and a USB input jack capable of receiving an image and image information from an external device of the electronic device 100 under the control of the processor 110. It will be apparent to one of ordinary skill in the art that the input/output unit may be added, deleted, and/or changed according to the performance and structure of the electronic device 100.

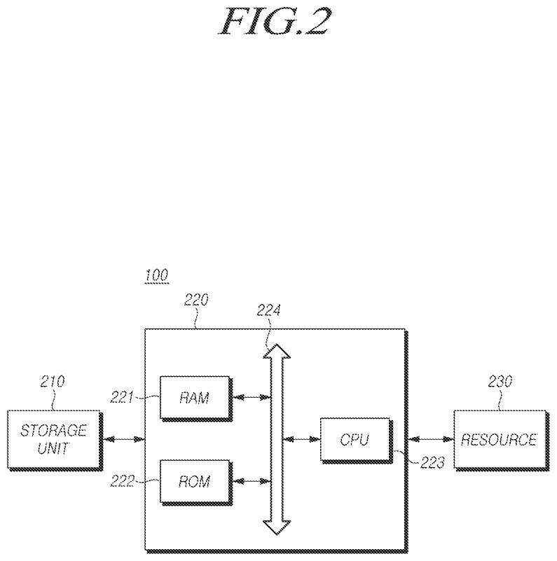

FIG. 2 is a block diagram illustrating an example configuration of an electronic device according to an embodiment of the disclosure.

Referring to FIG. 2, an electronic device 100 may include a storage unit (e.g., including a memory) 210, a processor (e.g., including processing circuitry) 220, and a resource (e.g., including circuitry) 230. The block configuration of FIG. 2 illustrates an example configuration of the electronic device 100 of FIG. 1, and descriptions overlapping those described with reference to FIG. 1 may not be repeated. The storage unit 210 of FIG. 2 may be a component corresponding to the memory 120 of FIG. 1, and the processor 220 may be a component corresponding to the processor 110 of FIG. 1.

In an embodiment, the storage unit 210 may store a package of an installed application (hereinafter, referred to as an “application package”). For convenience of description, it is illustrated that one application package is stored in the storage unit 210 of the electronic device 100, but there may be a plurality of application packages.

In an embodiment, the application package stored in the storage unit 210 may include an executable file package. The executable file package may include an executable file for driving the application, access control information included in the executable file, and a digital signature that encrypts the executable file and access control information.

According to an embodiment, the processor 220 may include a RAM 221, a ROM 222, a CPU 223, and a bus 224. The RAM 221, the ROM 222, and the CPU 223 may be connected to each other through the bus 224. The CPU 223 accesses the storage unit 210 and performs booting using the O/S stored in the storage unit 210. The CPU 223 may decrypt the command and perform various operations using various programs, contents, data, etc. stored in the storage unit 210. The processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the ROM 222 may store an instruction set for system booting. When a turn-on command is input and power is supplied to the electronic device 100, the CPU 223 may copy the O/S stored in the storage unit 210 to the RAM 221 according to the instruction stored in the ROM 222, and execute the O/S to boot the system. When booting is completed, the CPU 223 may copy various programs stored in the storage unit 210 to the RAM 221 and execute the programs copied to the RAM 221 to perform various operations.

In an embodiment, when an execution command for the installed application is input, the processor 220 may authenticate a plurality of execution files included in the application and a plurality of access control information corresponding to the plurality of execution files to set an access permission for the application. The processor 220 may store the authenticated access control information in the RAM 221 which is a volatile memory. For example, the CPU 223 of the processor 220 may store, in the RAM 221, access control information included in executable files which are assigned resource access permissions as authentication is completed among the plurality of access control information of the application stored in the storage unit 210.

The processor 220 may allow the application to access the resource 230 using the access control information stored in the RAM 221. When the application accesses the resource 230, it may refer, for example, to the processor 220 controlling the operation of the resource 230 using the executable file and access control information of the application or gather information from the resource 230 and process the gathered information. It is described above that the processor 220 includes only one CPU 223, but this is merely an example, embodiments of the disclosure may be implemented with a plurality of CPUs (or DSPs or SoCs).

In an embodiment, the resource 230 may be a component including various circuitry provided in the electronic device 100. For example, the resource may be at least one of a GPS chip (not shown), a video processor (not shown), a camera (not shown), a microphone (not shown), a speaker (not shown), a communication unit (not shown), an audio processor (not shown), and location information and a file of the electronic device 100 stored in the storage unit 210. When the playback application for the multimedia content is executed, the processor 220 may drive the video processor and the audio processor to play the corresponding content. The speaker may output audio data generated by the audio processor. The microphone may receive a user voice or other sound and convert the user voice or other sound into audio data. The processor 220 may use a user voice input through a microphone in a call process, or may convert the user voice into audio data and store the audio data in the storage unit 210. Meanwhile, the microphone may be configured as a stereo microphone that receives sound input at a plurality of locations. The camera may be configured to capture a still image or a video under the control of the user. A plurality of cameras may be implemented, such as a front camera and a rear camera. The resource may be a separate external server or another electronic device distinguished from the electronic device 100. For example, the resource may be an external server or another electronic device that may be accessed through an Internet site.

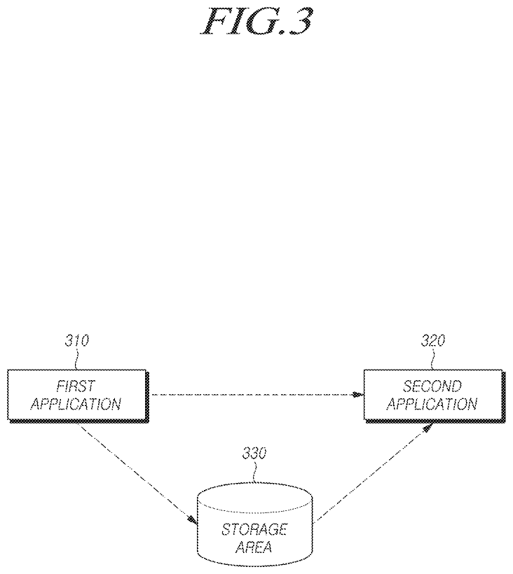

FIG. 3 is a diagram illustrating an example of communication between applications according to an embodiment of the disclosure. The first application 310 and the second application 320 of FIG. 3 may correspond to application programs stored in the memory of the electronic device 100. The storage area 330 of FIG. 3 may include a storage area of the electronic device 100. In the following description, it is illustrated that the first application 310 and the second application 320 are applications of the electronic device 100, but this is merely an example, and embodiments of the disclosure may be applied to applications installed on different devices. Further, it is assumed that the storage area 330 of FIG. 3 is a partial area of the memory of the electronic device 100, but this is merely an example, and the storage area 330 may include a partial area of the memory of a cloud server (not shown). In the description of FIG. 3, only two applications (the first application 310 and the second application 320) are described as an example, but various embodiments of the disclosure may be equally applied even when the electronic device 100 includes a plurality of applications. In the following description, the operation in which the first application 310 and the second application 320 request data and respond and store the data in the storage area may be an operation performed inside the electronic device 100 and may be an operation controlled by the operating system of the electronic device 100.

According to an embodiment, the first application 310 may transmit a data request to the second application 320. The first application 310 may transmit a data request to the second application 320 through an application programming interface (API) provided by the electronic device 100.

The data request may be a request for necessary data when the first application 310 intends to use at least one function provided by the second application 320.

At least one function may be any one of a function that requires confirmation of the access permission or a function that may be provided without confirmation of the access permission. Whether access permissions are required for at least one function provided by the application may be determined at the time when the second application 320 is installed.

Data regarding the first application 310 may be stored in any one of a first area (not shown) which is an area readable by an application signed with the same digital signature as the first application 310 or a second area which is an area readable by all applications. The storage area 330 to be described below may refer, for example, to the second area.

According to an embodiment, the authentication value generated by the first application 310 may be stored in the storage area 330. The authentication value may refer, for example, to a value randomly generated by the first application 310. The authentication value may include a value randomly generated by the first application 310 and a value indicating the time when the authentication value is generated.

The authentication value may be generated at or before the time when the first application 310 transmits a data request to the second application 320.

According to an embodiment, the data request transmitted from the first application 310 to the second application 320 may include information about the authentication value generated by the first application 310. In the following description, the authentication value generated by the first application 310 and stored in the storage area 330 may be referred to as a first authentication value, and the authentication value included in the data request by the first application 310 may be referred to as a “second authentication value”. The first authentication value and the second authentication value may be the same value or different values.

The information regarding the authentication value may include an authentication value and information regarding a path where the authentication value is stored. The information regarding the path where the authentication value is stored may refer, for example, to information regarding the path where the authentication value is stored in the storage area 330.

According to an embodiment, the second application 320 may identify the authentication value stored in the storage area 330, based on information included in the data request. Since the storage area 330 is an area accessible by an application having the same digital signature as the first application 310, when the second application 320 has a digital signature different from the digital signature of the first application 310, the first authentication value may not be read from the storage area 330. When the second application 320 has the same digital signature as the digital signature of the first application 310, the second application 320 may read the first authentication value from the storage area 330. The second application 320 may compare the identified first authentication value with the second authentication value included in the data request to determine whether to provide the data requested in the data request to the first application 310.

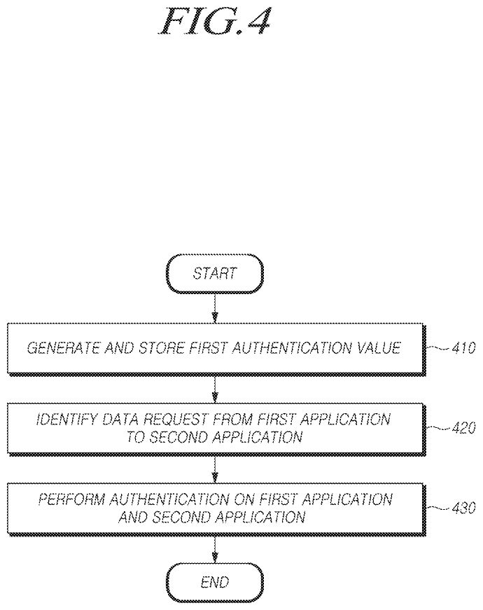

FIG. 4 is a flowchart illustrating example operations of an electronic device according to an embodiment of the disclosure. In the description of FIG. 4, descriptions overlapping those described with reference to FIGS. 1 to 3 may not be repeated. When the electronic device of FIG. 4 performs an operation for authentication between applications, it may be understood as an operation performed by an operating system.

According to an embodiment, in operation 410, the electronic device may generate and store the first authentication value. The first authentication value may refer, for example, to a value used for authentication of the first application.

The electronic device may generate a first authentication value including a random value and a Timestamp value according to the time when the random value is generated.

The electronic device may generate the first authentication value based on the information regarding the first application. For example, the first authentication value may be generated based on the identification information about the first application.

The electronic device may store the generated first authentication value in the storage area. The storage area may refer, for example, to an area corresponding to the storage area 330 of FIG. 3. In other words, the electronic device may store the generated first authentication value in a storage area accessible by an application having the same digital signature as the first application.

In an embodiment, the storage area may refer to an area that is accessible by only a device having the same digital signature as the first application among areas in which data regarding the first application is stored. The area in which the data regarding the first application is stored may include an area accessible by all applications and an area accessible only by devices having the same digital signature as the first application. The storage area in which the electronic device stores the first authentication value may refer, for example, to an area accessible only by a device having the same digital signature as the first application.

In an embodiment, the storage area may be a partial area of one storage area of the electronic device, and may be a storage area that allows access to only an app signed with a designated digital signature. In other words, rather than the area storing data regarding the application being separated, data regarding all applications may be stored in one area, and a specific area thereof may need to be confirmed as being signed with a designated digital signature for access. The storage area may refer, for example, to the specific area.

In an embodiment, the storage area is a partial area of one storage area of the electronic device, and may refer, for example, to an area that allows access to only at least one designated digital signature. In other words, a separate second application may be present which is accessible with each digital signature. In this case, the accessible storage area may be different depending on the type of the digital signature of the application.

According to an embodiment, in operation 420, the electronic device may identify the data request from the first application to the second application.

The first application may transmit, to the second application, a data request for requesting to perform at least one function that requires permission. The data request may include an authentication value of the first application. The authentication value included in the data request may be referred to as a second authentication value. The first authentication value and the second authentication value may have the same value or different values.

In an embodiment, the data request from the first application to the second application may include information regarding the path where the authentication value is stored. The electronic device may identify the location where the first authentication value is stored based on the information regarding the path where the authentication value is stored and compare the digital signature of the area with the digital signature of the second application.

In an embodiment, the data request from the first application to the second application may not include the information regarding the path where the authentication value is stored and, in this case, the second application may identify the area where the first authentication value is stored based on information regarding at least one predetermined path included in the data regarding the second application. In this case, rather than receiving the storage path from the first application, only the path according to information already stored in the second application is searched, so that verification may be performed at a higher security level.

According to an embodiment, in operation 430, the electronic device may authenticate the first application and the second application.

The electronic device may identify the area where the first authentication value is stored based on information regarding the path where the authentication value included in the data request from the first application to the second application is stored or information regarding at least one predetermined path stored in the data regarding the second application.

When the digital signature of the storage area where the first authentication value is stored is compared with and matches the digital signature of the second application, the electronic device may identify the first authentication value stored in the storage area. When the digital signature of the storage area where the first authentication value is stored is compared with and does not match the digital signature of the second application, the electronic device may not identify the first authentication value stored in the storage area, and thus the data request from the first application to the second application may be rejected. When the digital signatures match each other, it may refer, for example, to the developer of the first application matching the developer of the second application, so that they are applications reliable to each other.

When the first authentication value is identified, the electronic device may compare the identified first authentication value with the second authentication value included in the data request. When the first authentication value matches the second authentication value, the electronic device may provide data requested by the first application from the second application to the first application. When the first authentication value does not match the second authentication value, the electronic device may display a user interface indicating (or, informing) that data requested by the first application is not processible.

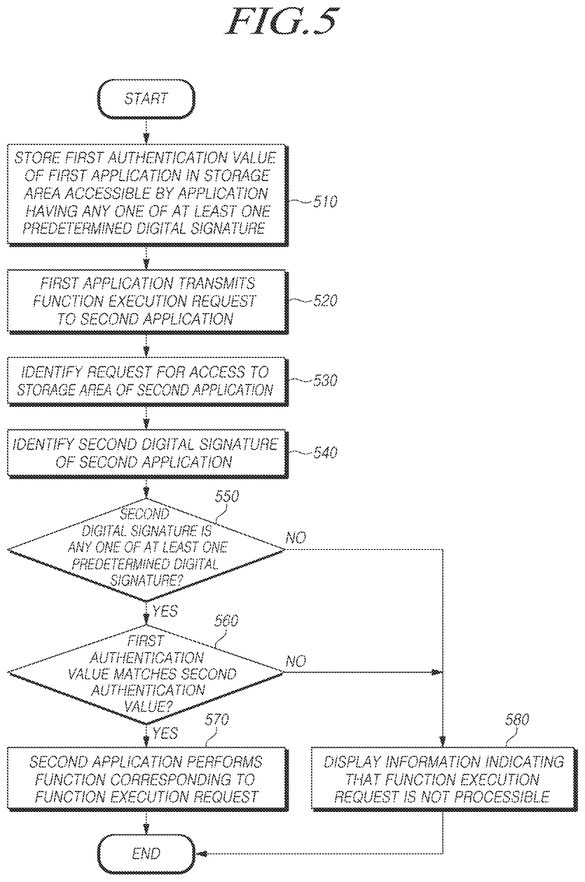

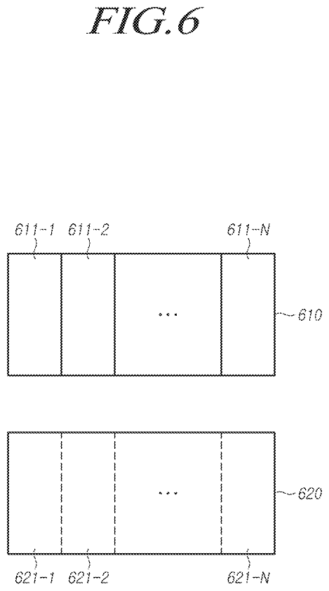

FIG. 5 is a flowchart illustrating example operations of an electronic device according to an embodiment of the disclosure. FIG. 6 is a diagram illustrating an example of a storage area according to an embodiment of the disclosure. In the description of FIG. 5, the same description as those described with reference to FIGS. 1 to 4 may not be repeated.

According to an embodiment, in operation 510, the electronic device may store the first authentication value in a storage area accessible by an application having a predetermined digital signature. The predetermined digital signature may include at least one predetermined digital signature.

In an embodiment, the at least one predetermined digital signature may include the digital signature of the first application.

In an embodiment, the storage area may include the storage area 330 of FIG. 3 and an area corresponding to the storage area accessible only by an application having the same digital signature as the first application of FIG. 4.

In an embodiment, referring to FIG. 6, the storage area may refer, for example, to a partial area of the area 611-1 where data regarding the first application is stored of the entire storage area 610. Although not shown in the drawings, the area 611-1 may include an area accessible by all applications and an area accessible only by devices having the same digital signature as the first application.

In an embodiment, referring to FIG. 6, the storage area may refer, for example, to an area 621-1 of the entire storage area 620, accessible only by an application having the same digital signature as a specific digital signature (e.g., the digital signature of the first application). The entire storage area 610 and the entire storage area 620 both may refer, for example, to a storage area of a platform of the electronic device, but the entire storage area 610 is divided for each application (e.g., store data regarding the first application in the area 611-1 and data regarding the second application in the area 611-2) while the entire storage area 620 is not divided for each application but is a single area in which the access permission differs for each area (e.g., the area 621-1 accessible by an application having the first digital signature and the area 621-2 accessible by an application having the second digital signature).

The digital signature may refer, for example, to electronic and encrypted authentication information for an application. The digital signature of the application may be used to identify that the code of the application has not been changed, and may be used to identify that the developer of the application is a reliable developer. Authentication and integrity of the application may be verified using a method through a digital signature.

The first authentication value may refer, for example, to a value corresponding to the first authentication value described above with reference to FIGS. 3 and 4. In other words, the first authentication value may refer, for example, to any value generated based on information regarding the first application and information regarding the time of generation by the first application.

According to an embodiment, in operation 520, the first application may transmit a function execution request to the second application.

In an embodiment, the function execution request may be a request for the first application to perform at least one function of the second application.

In an embodiment, the function execution request may include information regarding the second authentication value and information regarding the storage path of the second authentication value.

According to an embodiment, in operation 530, the electronic device may identify an access request for the storage area of the second application.

In an embodiment, the electronic device may identify the storage location of the second authentication value, based on the information regarding the storage path of the second authentication value or at least one predetermined path stored in the data related to the second application. The electronic device may identify that the storage location of the second authentication value is the storage area, and request information regarding the authentication value stored in the storage area.

According to an embodiment, in operation 540, the electronic device may identify information regarding the second digital signature of the second application. Operation 540 may include all of the operations according to operation 430 of FIG. 4. An example of identifying information regarding a digital signature is described below, but this is merely an example. Authentication may be performed through other content (e.g., identifying the owner of the corresponding storage area or directory and group information or identifying access permission (permission to read, write, or execute)) related to the access permission.

The electronic device may identify information regarding the digital signature of the second application in response to identifying the access request for the storage area. This may include extracting digital signature information from the executable file of the second application. The information regarding the digital signature may include information such as the issuer of the application, expiration period, and public key.

According to an embodiment, in operation 550, the electronic device may determine whether the second digital signature corresponds to any one of predetermined digital signatures.

In an embodiment, the electronic device may determine whether the second digital signature is the same as any one of at least one predetermined digital signature by comparing the information regarding the first digital signature and the information regarding the second digital signature. When the information regarding the digital signatures is the same, the second application may be identified as an application having the same digital signature as the digital signature of the first application.

In an embodiment, when the electronic device determines that the second digital signature corresponds to a predetermined digital signature (Yes in operation 550), the electronic device may perform operation 560.

In an embodiment, when the electronic device determines that the second digital signature does not correspond to a predetermined digital signature (No in operation 550), the electronic device may perform operation 580.

In an embodiment, when determining that the second digital signature corresponds to the predetermined digital signature, the electronic device may allow access to the storage area of the second application.

In an embodiment, when determining that the second digital signature does not correspond to the predetermined digital signature, the electronic device may not allow access to the storage area of the second application.

According to an embodiment, in operation 560, the electronic device may determine whether the first authentication value matches the second authentication value.

In an embodiment, the electronic device may determine whether the second authentication value which is an authentication value included in the function execution request identified by the second application matches the first authentication value which is an authentication value actually stored in the storage area.

In an embodiment, when determining that the first authentication value matches the second authentication value (Yes in operation 560), the electronic device may perform operation 570.

In an embodiment, when determining that the first authentication value does not match the second authentication value (No in operation 560), the electronic device may perform operation 580.

According to an embodiment, in operation 570, the electronic device may provide data corresponding to the function execution request to the first application.

In an embodiment, the electronic device may provide data for executing at least one function requested in the function execution request or data regarding the result of execution of at least one function to the first application. Since success in authentication is identified according to operations 550 and 560, the electronic device may provide the data requested by the first application to the second application.

According to an embodiment, in operation 580, the electronic device may display information indicating that the data corresponding to the function execution request is not processible.

In an embodiment, in operation 550 or operation 560, since authentication of the first application and the second application fails, the electronic device may display a user interface including information indicating that the data is not processible.

In an embodiment, the user interface may include an object for identifying a user input regarding whether to provide the function of the second application to the first application and the information indicating that data is not processible. When identifying a user input through the object, the electronic device may provide the function of the second application to the first application despite failure in authentication in operations 550 and 560.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device 100 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure is illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for operating an electronic device, the method comprising:
storing, by a first application, a first authentication value of the first application in a storage area accessible by an application having a specified digital signature, the first application having a first digital signature capable of accessing the storage area;
transmitting, by the first application, a function execution request and a second authentication value to a second application;
identifying a second digital signature of the second application based on identifying a request for access to the storage area of the second application;
based on the second digital signature corresponding to the specified digital signature, allowing access to the storage area of the second application;
performing, by the second application, authentication on the first application based on the first authentication value identified in the storage area and the second authentication value received from the first application; and
based on performing the authentication, performing, by the second application, a function corresponding to the function execution request.

2. The method of claim 1, wherein the function execution request includes information about a storage path of the first authentication value.

3. The method of claim 1, wherein identifying the request for access to the storage area of the second application includes:
identifying a specified access path for the second application; and
identifying the storage area among areas accessible through the specified access path.

4. The method of claim 1, wherein the storage area includes a partial area of an area storing data for the first application, and
wherein data regarding an application other than the first application is not stored.

5. The method of claim 1, wherein the storage area includes a partial area of an area storing data regarding the first application and the second application.

6. The method of claim 1, wherein the specified digital signature includes the first digital signature including a digital signature of the first application.

7. The method of claim 1, wherein performing the function corresponding to the function execution request by the second application includes providing data regarding the function to the first application by the second application.

8. The method of claim 1, comprising displaying a user interface informing that data corresponding to the function execution request may not be provided, based on information regarding the extracted first digital signature not being the same as information regarding the second digital signature.

9. The method of claim 1, wherein the user interface includes an object for identifying an input regarding whether to provide a function regarding the second application to the first application.

10. The method of claim 1, wherein the first authentication value includes a value randomly generated according to a time when the first authentication value is generated.

11. The method of claim 1, wherein the storage area includes a partial area of a memory area of the electronic device.

12. The method of claim 1, wherein the storage area includes a partial area of a memory area of a cloud server connected with the electronic device.

13. The method of claim 1, wherein the first application includes an application installed on the electronic device, and
wherein the second application includes an application installed on an external electronic device connected with the electronic device.

14. An electronic device, comprising:
memory; and
at least one processor, comprising processing circuitry, electrically connected to the memory, wherein at least one processor, individually and/or collectively, is configured to:
store, by a first application, a first authentication value of the first application in a storage area accessible by an application having a specified digital signature, the first application having a first digital signature capable of accessing the storage area;
transmit, by the first application, a function execution request and a second authentication value to a second application;
identify a second digital signature of the second application based on identifying a request for access to the storage area of the second application;
based on the second digital signature corresponding to the specified digital signature, allow access to the storage area of the second application;
perform, by the second application, authentication on the first application based on the first authentication value identified in the storage area and the second authentication value received from the first application; and
based on performing the authentication, perform, by the second application, a function corresponding to the function execution request.

15. The electronic device of claim 14, wherein at least one processor, individually and/or collectively, is configured to:
identify the request for access to the storage area of the second application;
identify a specified access path for the second application; and
identify the storage area among areas accessible through the specified access path.

16. The electronic device of claim 14, wherein the storage area includes a partial area of an area storing data for the first application, and
wherein data regarding an application other than the first application is not stored.

17. The electronic device of claim 14, wherein the storage area includes a partial area of an area storing data regarding the first application and the second application.

18. The electronic device of claim 14, wherein the specified digital signature includes the first digital signature including a digital signature of the first application.

19. The electronic device of claim 18, wherein at least one processor, individually and/or collectively, is configured to provide a data response including data corresponding to the function execution request to the first application.

20. The electronic device of claim 14, further comprising a display,
wherein at least one processor, individually and/or collectively, is configured to display, through the display, a user interface informing that data corresponding to the function execution request may not be provided, based on information regarding the extracted first digital signature not being the same as information regarding the second digital signature.
